(19) United States
(12) Patent Application Publication
(10) Pub. No.: US 2026/0301035 A1
(43) Pub. Date: Oct. 1, 2026

(54) DYNAMIC ITEM LISTING ENGINE

(71) Applicant: eBay Inc., San Jose, CA (US)

(72) Inventors: Devarshi Himanshubhai VYAS, San Jose, CA (US); Shreemad Sanskarbhai Patel, Campbell, CA (US); Sophia Thitirat Perl, San Jose, CA (US)

(21) Appl. No.: 19/092,846

(22) Filed: Mar. 27, 2025

(51) Int. Cl. G06Q 30/0601

(52) U.S. Cl. CPC G06Q 30/0601; G06Q 30/0641

(57) ABSTRACT

Methods, systems, and computer storage media for providing a dynamic item listing engine in an item listing system are described. The dynamic item listing engine automates and optimizes the creation, scheduling, and management of item listings in an item listing system. The dynamic item listing engine utilizes a combination of automated data extraction from multiple sources (e.g., purchase receipts, websites), threshold-based logic for evaluating data completeness, and personalized recommendations based on seller activity. The dynamic item listing engine ingests receipt information via various channels (e.g., email, plugins, or APIs), extracts data using content parsing and web scraping, and uses rules-based logic to supplement and refine item listings dynamically. The dynamic item listing engine provides an adaptive threshold evaluation to dynamically adjust data quality criteria, an intelligent scheduling algorithm automatically selects optimal publication times for listings; and a multi-carrier shipping optimization that aggregates data from various carriers to identify shipping options.

### BACKGROUND

Users can interact with item listing systems that support storing items in item databases and providing a search system for receiving queries and identifying search result items based on the queries. The item listing system provide a seamless user experience when browsing through a variety of products. The item listing system allows users to search and discover products through a detailed and organized catalog, enhancing the browsing process. The item listing system may also incorporate features that support the item listing, such as dynamic item categorization, real-time inventory updates, and customizable filtering options. Sellers can manage and update their product listings, adjusting prices, descriptions, availability, and images with ease. This ensures that customers always see accurate, up-to-date information. The item listing system ensures smooth interaction between buyers and sellers by allowing real-time updates to listings, offering recommendations based on user preferences or browsing history, and managing inventory to prevent overselling.

### SUMMARY

Various aspects of the technology described herein are generally directed to systems, methods, and computer storage media for, among other things, providing a dynamic item listing engine that automates and optimizes the creation, scheduling, and management of item listings in an item listing system. The dynamic item listing engine utilizes a combination of automated data extraction from multiple sources (e.g., purchase receipts, websites), threshold-based logic for evaluating data completeness, and personalized recommendations based on seller activity. The dynamic item listing engine ingests receipt information via various channels (e.g., email, plugins, or APIs), extracts structured data using content parsing and web scraping, and uses rules-based logic to supplement and refine item listings dynamically.

In operation, receipt data from an electronic communication is accessed. The receipt data is associated with an item and a user. The item listing data for the item is extracted from the receipt data. Based on the item listing data, an item listing for the item on an item listing system is automatically generated. Using a dynamic item listing rule, one attribute of the item listing is updated, the dynamic item listing rule is a first user-specific configuration that determines a creation of the item listing. Using a dynamic publishing rule, the item listing for publishing on the item listing system is scheduled. The dynamic publishing rule is a second user-specific configuration that determines a publishing of the item listing.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1A is block diagram associated with providing dynamic item listing engine management in an item listing system, in accordance with aspects of the technology described herein;

FIG. 1B-1F are schematics associated with providing dynamic item listing engine management in an item listing system, in accordance with aspects of the technology described herein;

FIG. 2A is a block diagram associated with providing dynamic item listing engine management, in accordance with aspects of the technology described herein;

FIG. 2B is a flow diagram associated with providing dynamic item listing engine management, in accordance with aspects of the technology described herein;

FIG. 3 provides a first exemplary method of providing dynamic item listing management in an item listing system, in accordance with aspects of the technology described herein;

FIG. 4 provides a second exemplary method of providing dynamic item listing management in an item listing system, in accordance with aspects of the technology described herein;

FIG. 5 provides a third exemplary method of providing dynamic item listing management in an item listing system, in accordance with aspects of the technology described herein

FIG. 6 provides a block diagram of an exemplary item listing system computing environment suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION

### Overview

An item listing system and platform support storing items (products or assets) in item databases and providing a search system for receiving queries and identifying search result items based on the queries. An item (e.g., physical item or digital item) refers to a product or asset that is provided for listing on an item listing platform. Search systems support identifying, for received queries, result items from item databases. Item databases can specifically be for content platform or item listing platforms such as EBAY content platform, developed by EBAY INC., of San Jose, California.

An item listing system may also provide generative-AI-supported applications (“generative AI applications”) that leverage generative AI models (e.g., Large Language Models-“LLM”) to create, generate, or produce content, data or outputs. LLMs are a specific class of generative AI models that are primarily focused on generating human-like text. Generative AI models, like GPT (Generative-Pre-trained Transformer) and its variants, are designed to generate human-like text or other types of data based on the input they receive (e.g., via a prompt interface). These applications use generative AI to perform various task across different domains to provide improvement in automation, efficiency, and human-like interaction.

An item listing system supports item listing functionality that enables users to seamlessly add, manage, and display products in a structured and organized manner. When creating a new listing, users, typically sellers, input detailed information about the product, such as its name, description, price, images, and relevant attributes like size, color, and category. The item listing system ensures that required fields are completed properly and may include validations to confirm that the data adheres to necessary formats, such as ensuring that prices are entered as numerical values. This process allows sellers to accurately showcase their products to potential buyers.

Once an item is listed, the item listing system provides tools for ongoing management. Sellers can easily update their product listings as needed, adjusting prices, modifying descriptions, adding new images, or changing product availability. For example, they may adjust stock levels, update promotional details, or remove the listing entirely when a product is no longer available. These features ensure that the product catalog remains up-to-date and reflects the latest changes in the inventory. Additionally, the item listing system typically includes inventory management functionality to keep track of stock levels in real-time. Sellers can monitor their inventory and adjust product availability as needed, ensuring that products listed as “out of stock” are not mistakenly made available for purchase. The system may also provide alerts to notify sellers when stock is running low, prompting them to restock items and avoid potential sales disruptions.

Conventional item listing systems are not configured with a comprehensive computing logic and infrastructure to effectively optimize item listing management. Manually creating and managing item listings is a labor-intensive and error-prone process, requiring sellers to manually extract and organize detailed product information from various sources, such as purchase receipts, websites, or other external repositories. Sellers often struggle with incomplete or inconsistent data, making it difficult to quickly create accurate and informative listings. Moreover, existing item listing systems lack an integrated, automated mechanism for enhancing the listing creation process, including the ability to retrieve supplemental information from external sources, set scheduling preferences, or leverage historical purchase data. This leads to inefficiencies in item listing generation and management, resulting in delayed listings, inaccuracies in the information presented, and missed opportunities to effectively engage with potential buyers. Furthermore, sellers may fail to optimize the listing experience by utilizing tailored recommendations, personalized alerts, or data-driven actions, which would help increase visibility and sales potential. As a result, the current item listing systems fail to streamline listing creation and management, ultimately reducing overall item listing system effectiveness and seller satisfaction.

By way of example, Sarah, a fashion-forward individual, has recently cleaned out her closet and decided to sell a few high-end pieces on an item listing system. She begins the listing process by locating receipts for her purchases, but soon runs into a problem: the information on the receipts is incomplete, with no details about specific sizes, colors, or product descriptions. She spends extra time browsing various websites and searching her email for more detailed product information, manually typing everything into the listing form. Even after gathering this extra data, Sarah struggles to categorize the items correctly, adjust the pricing for competitive listings, and set an appropriate shipping method. Ultimately, her time is wasted, the listings take longer to create, and some potential buyers lose interest due to inaccuracies or missing information. As a result, Sarah's reselling experience lacks the efficiency and smoothness she had hoped for, making it difficult for her to make the most of her closet's potential. In the absence of tailored recommendations, personalized alerts, or data-driven actions further hampers Sarah's ability to optimize the listing experience, ultimately reducing the overall effectiveness of the item listing system and diminishing seller satisfaction. As such, a more comprehensive dynamic item listing engine—with an alternative basis for providing dynamic item listing management functionality—can improve computing operations and interfaces for item listing systems.

### DESCRIPTION OF TECHNICAL SOLUTION

At a high level, a dynamic item listing engine supports dynamic item listing engine management in an item listing system. In particular, the dynamic item listing engine automates and optimizes the creation, scheduling, and management of item listings in the item listing system. The dynamic item listing engine streamlines the item listing process by automating several key functions. The dynamic item listing engine begins with automated data retrieval, parsing receipt content and dynamically scraping supplemental information from various product sources to ensure that each listing is as comprehensive and accurate as possible.

This dynamic item listing engine automates the creation and management of item listings by interfacing with various external and internal data sources through APIs and plugins—APIs (Application Programming Interfaces) are standardized protocols that allow the dynamic item listing engine to communicate with various external and internal data sources; plugins are modular software components that extend the core functionality of the dynamic item listing engine by facilitating seamless integration with specific external data sources or services. The dynamic item listing engine synchronizes the item listing data to ensure that all data obtained from the receipt and supplementary sources is aligned, consistent, and up to date across the system. This process involves reconciling any differences between various data inputs and updating the central listing information so that the final output accurately reflects the most current and complete set of product details.

The dynamic item listing engine employs threshold-based processing, evaluating whether the extracted data is sufficient to generate a listing or if further input is required, triggering additional actions such as external crawling or administrative intervention when necessary. Users can also set or adjust listing schedules through the dynamic item listing engine, with the added feature of receiving notifications, allowing for last-minute changes before listings go live. The dynamic item listing engine also offers personalized recommendations, analyzing purchase history to suggest related listings, relevant promotions, or advertising opportunities based on user preferences. Additionally, the dynamic item listing engine integrates with shipping APIs, automating the retrieval and population of essential shipping details for each item, ensuring that all logistical information is accurately included in the listing.

Operationally, the dynamic item listing engine supports orchestrating dynamic item listing management that includes generating, refining, and managing item listings. At its core, the dynamic item listing engine integrates multiple functions and components to transform raw data into polished, ready-to-publish listings while automating routine tasks and ensuring high data quality.

The process begins with the receipt parser, which is responsible for extracting key product information from incoming purchase receipts. For example, when a seller receives an email confirmation for a clothing purchase, the receipt parser automatically identifies details such as the product name, price, size, and purchase date. This extracted information forms the foundation for the listing. If, however, the receipt data is incomplete or lacks certain visual or descriptive elements, a threshold-based processing engine is employed to evaluate the completeness and quality of the extracted data against predefined criteria; if the data does not meet these thresholds, it triggers a web scraper. The seller's email account acts as the primary input source, delivering receipts and purchase confirmations that initiate the listing process. Additionally, external data sources such as retailer websites and product databases are accessed via the web scraper to fill in missing information, ensuring that listings are complete and compelling.

The web scraper serves as a supplemental tool by navigating external data sources, such as retailer websites or third-party databases, to retrieve missing details like high-resolution images or extended product descriptions. For instance, if the receipt only mentions the product name and price, the web scraper can fetch detailed specifications and multiple images directly from the retailer's online catalog (i.e., an external data source), enriching the information available for the listing.

Once sufficient data is collected, the rules-based logic engine applies user-defined or system-generated rules to adjust listing parameters. The rules-based logic engine might automatically update the listing price based on the age of the item or categorize the item according to pre-established rules—such as placing a jacket in the “Men's Outerwear” category if it meets certain criteria. This ensures consistency and relevance across listings while minimizing manual interventions.

The scheduler for listing publication is then used to manage when the listing goes live. Based on historical engagement data and seller preferences, the scheduler for listing publication might schedule a listing to be published at peak times, such as weekend evenings, to maximize buyer exposure. In parallel, the shipping API integration connects with external shipping carrier systems (such as UPS, FedEx, or USPS) via their APIs to automatically retrieve shipping-related details—like package dimensions, weight, and real-time shipping rates—and incorporate this information into the listing. For example, when listing a pair of shoes, the dynamic item listing engine uses the shipping API to calculate the shipping cost and generate a shipping label automatically.

The shipping API integration automatically extracts shipping data from purchase receipts to provide detailed shipping options for both sellers and buyers. When a receipt is parsed, key information like package dimensions, weight, and sometimes the carrier is captured and used to retrieve shipping options, including available carriers, service levels, and estimated delivery times. The dynamic item listing engine analyzes historical shipping data to suggest the most cost-effective and reliable shipping methods based on package characteristics. For instance, if a receipt specifies a 2 lb. package, the API might recommend UPS ground shipping at $7.95 with a 3-5 day delivery window, while also offering an expedited shipping option based on past sales trends. This integration streamlines the listing process by providing tailored shipping choices that enhance the buyer's experience.

Enhancing the overall seller experience, a personalization and recommendation engine analyzes historical data, including past purchases and listing performance, to offer tailored suggestions. This could include recommendations to bundle similar items or adjust pricing strategies based on current market trends. Meanwhile, an analytic engine supports continuously monitors key performance metrics, such as view counts, click-through rates, and conversion rates, providing insights that help sellers understand which listings are performing well and which may need further optimization.

The analytics engine aggregates and analyzes receipt data to offer insights into users' shopping patterns, which helps manage their digital wardrobe and improve item listing performance. It tracks details like purchase dates, prices, brands, and categories, applying analytical models to identify trends, such as frequent purchases from certain brands or categories. By correlating this data with historical listing performance—such as views and conversion rates—the engine provides actionable insights for sellers. For example, it might recommend listing seasonal sale items during peak times or creating themed collections based on user habits. This enables users to make informed decisions, enhancing both their organization and sales success.

A notification module works in tandem with these components by sending alerts to the seller-informing them when a draft listing is ready for review, when changes are recommended, or when a scheduled listing is about to go live. All of these functions are accessible through a user interface dashboard, which presents a consolidated view of the entire process. This dashboard allows sellers to manage listings, view performance analytics, adjust settings, and interact with personalized recommendations in a user-friendly manner.

By way of example, consider Sarah, an avid fashion enthusiast and occasional seller who uses the dynamic item listing engine to manage her online closet. One day, Sarah receives an email receipt for a new pair of vintage denim jeans she purchased online. Instead of manually creating a listing, Sarah simply forwards the receipt to a designated dynamic item listing engine email alias. The dynamic item listing engine receipt parser immediately kicks in, extracting key details from the email such as the product name, purchase price, brand, size, and transaction date. Noticing that the receipt lacks high-quality images and a detailed description, the threshold-based processing module flags the data as incomplete and triggers the web scraper. The web scraper then automatically navigates to the retailer's website to fetch additional details—retrieving several high-resolution images and an extended product description—to complement the parsed information.

Once the necessary data is complete, the rules-based logic engine applies pre-set rules to the listing; for example, it may automatically apply a 15% discount if the jeans have been in Sarah's wardrobe for over 90 days, or it might categorize the item under “vintage denim” based on its attributes. The shipping API integration connects with external carriers to retrieve real-time shipping options; it calculates shipping rates based on the item's weight and dimensions and suggests the most cost-effective shipping methods along with estimated delivery times. With all data verified and enriched, the scheduler for listing publication determines the optimal time to publish the listing by analyzing historical engagement data-scheduling the listing for a weekend evening when buyer traffic is highest.

The personalization module for recommendations can review Sarah's digital wardrobe and previous sales performance, then suggests that she consider bundling the jeans with a complementary vintage jacket to potentially boost her sales. After final confirmation, the listing is automatically published, and the analytics module begins tracking key performance metrics such as views, click-through rates, and conversion rates. The notification module keeps Sarah informed by sending real-time alerts via her mobile app whenever an important event occurs—like when the listing is about to go live or if the system recommends making adjustments based on buyer engagement data. Throughout the process, Sarah can monitor and manage her listings via an intuitive user interface dashboard that provides a comprehensive view of her digital closet, performance analytics, and personalized suggestions for future sales. This integrated process not only automates the traditionally labor-intensive task of creating and managing item listings but also optimizes each listing for better market performance, ultimately saving Sarah time while enhancing both her selling efficiency and buyer satisfaction.

### Example System and Resources

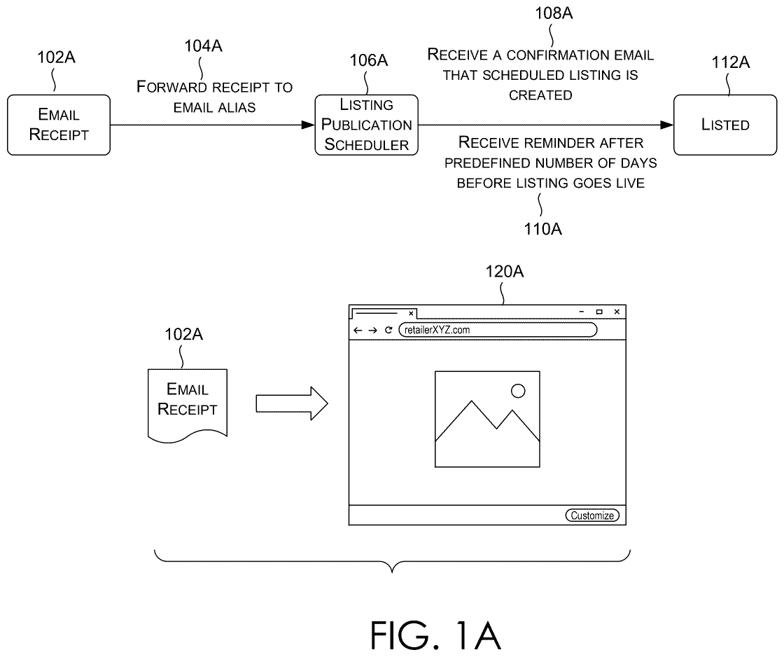

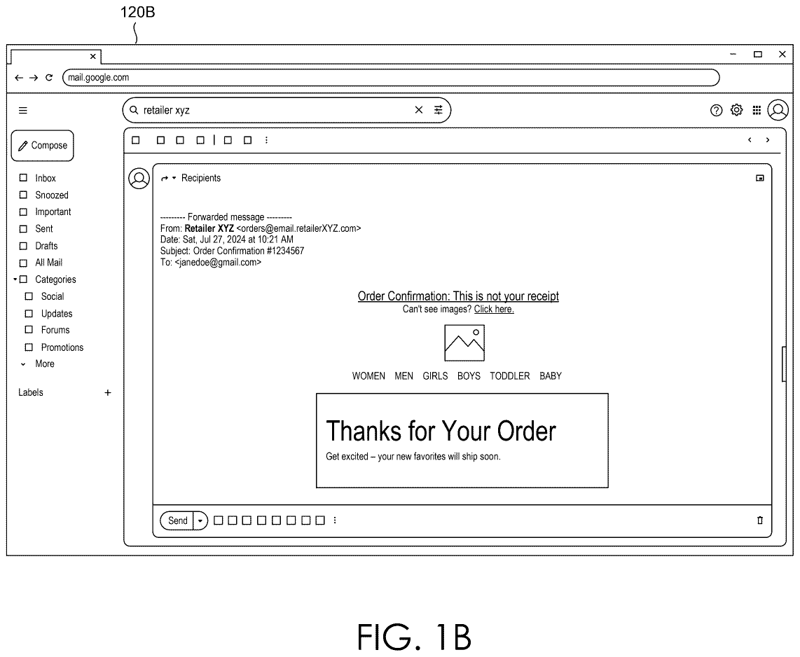

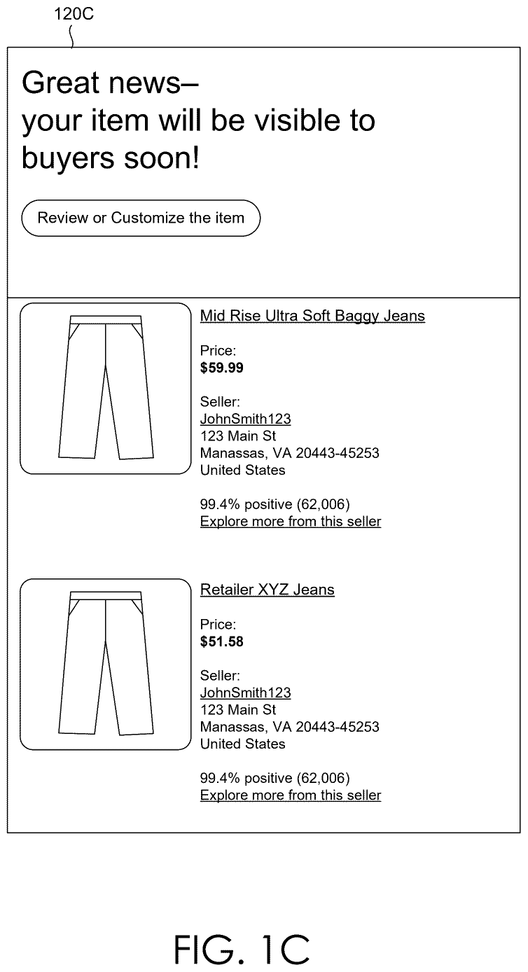

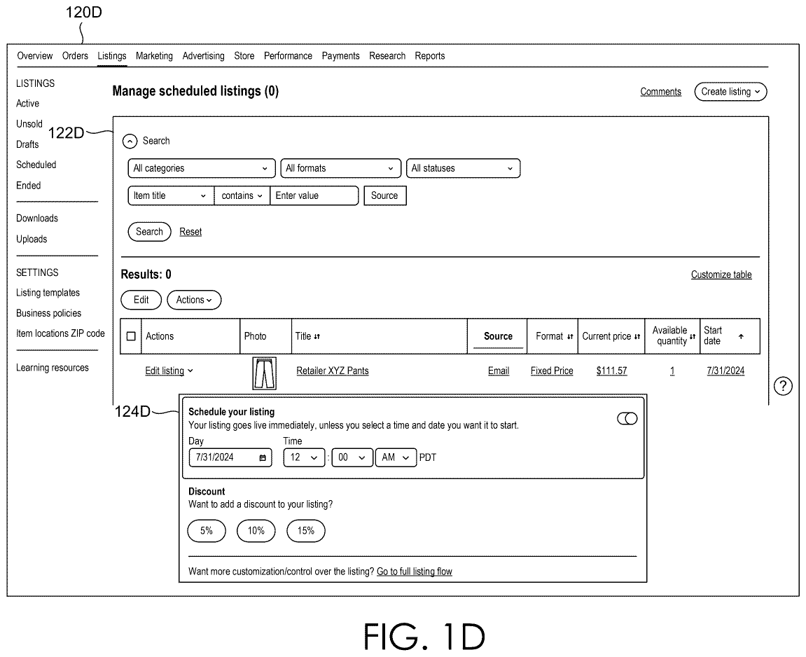

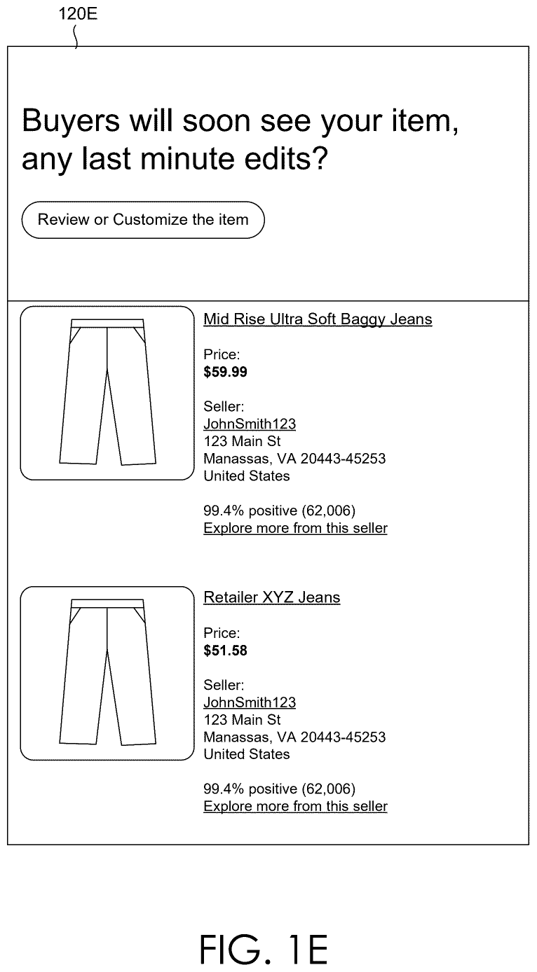

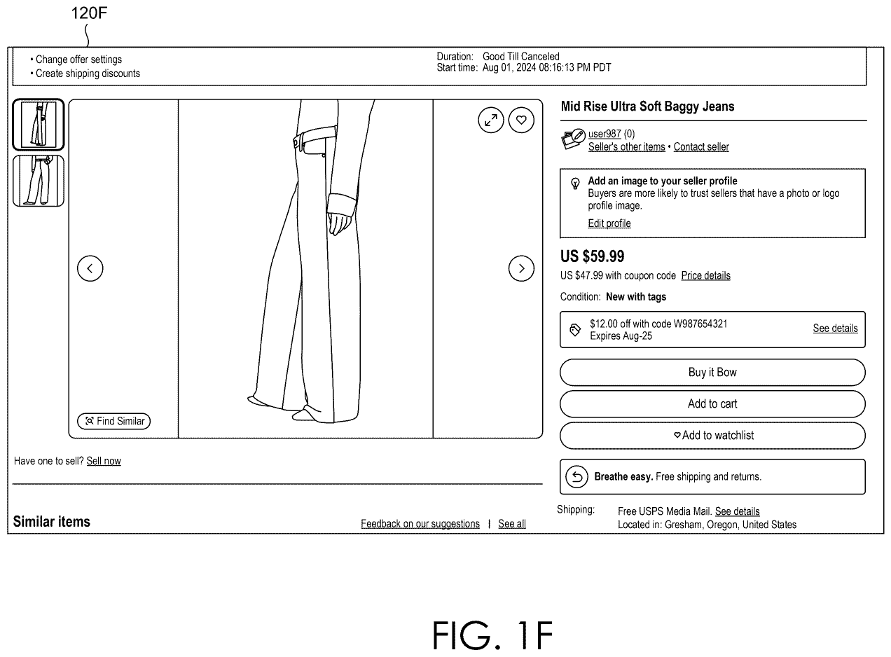

Aspects of the technical solution can be described by way of examples and with reference to FIGS. 1A-1B. FIG. 1A illustrates a flow diagram associated with providing item listing management using a dynamic item listing engine. As shown in this example implementation, an email receipt 102A is received by a user, which typically contains purchase details. The user can simply forward 104A this email to an item listing service via a designated email alias, which triggers the process for creating a new e-commerce listing.

As depicted in FIG. 1A, the dynamic item listing engine is designed to automatically extracts relevant information from the email receipt 102A, which includes details such as the product name, quantity, price, and other key information necessary for the listing. The item listing system provide an item listing interface 120A that is associated with providing interface elements for various functionalities, ensuring that an efficient workflow is followed.

Once the necessary product data is acquired, the listing publication scheduler 106A determines the optimal time to publish the item listing, taking into account factors such as user preferences and market trends. The dynamic item listing engine then sends a confirmation 108A email to notify the user that their listing has been successfully scheduled. Closer to the listing's publication time, the user will receive a reminder 110A after a predefined number of days, ensuring that the user has enough time to review and finalize the listing before it goes live. Finally, once the designated time arrives, the item is listed 112A and the item appears for sale on the item listing system.

With reference to FIGS. 1B-1F, FIGS. 1B through 1F, illustrate user interfaces associated with the dynamic item listing engine, demonstrating how the dynamic item listing engine seamlessly integrates multiple functions to automate and optimize the item listing process. In FIG. 1B, interface 120B displays the screen where a user forwards their email receipt to the designated email alias, triggering the receipt parser and data acquisition engine within dynamic item listing engine to extract and normalize the relevant product information.

FIG. 1C then depicts a reminder notification 120C generated by a listing publication scheduler, alerting the user that their item will soon be visible to buyers-a feature that leverages historical engagement data to optimize publication timing.

FIG. 1D shows a more comprehensive interface 120D designed for managing scheduled listings; it comprises several portions. For example, a managed scheduled listings interface portion 122D includes functionalities such as categorization, search, and digital wardrobe management, allowing users to organize and review their inventory; the schedule your listing interface 124D, provides options to set publication parameters—such as the day, time, discount levels, and other attributes—demonstrating the integration of the rules-based logic engine and scheduler within dynamic item listing engine. Should the user update any listing details, a subsequent reminder notification 120E is issued, as depicted in FIG. 1E, ensuring that the user remains informed and in control as the listing approaches publication.

Finally, FIG. 1F presents a listed item interface 120F, where the finalized item listing is displayed with detailed information including the item title, price, and additional listing features, reflecting the output of the dynamic item listing engine after all data enrichment, scheduling, and shipping API integration processes have been completed. This series of interfaces collectively exemplifies how the technical solution automates data extraction, enhances listing management, and optimizes publication timing, all while providing a user-friendly experience that supports efficient digital inventory management.

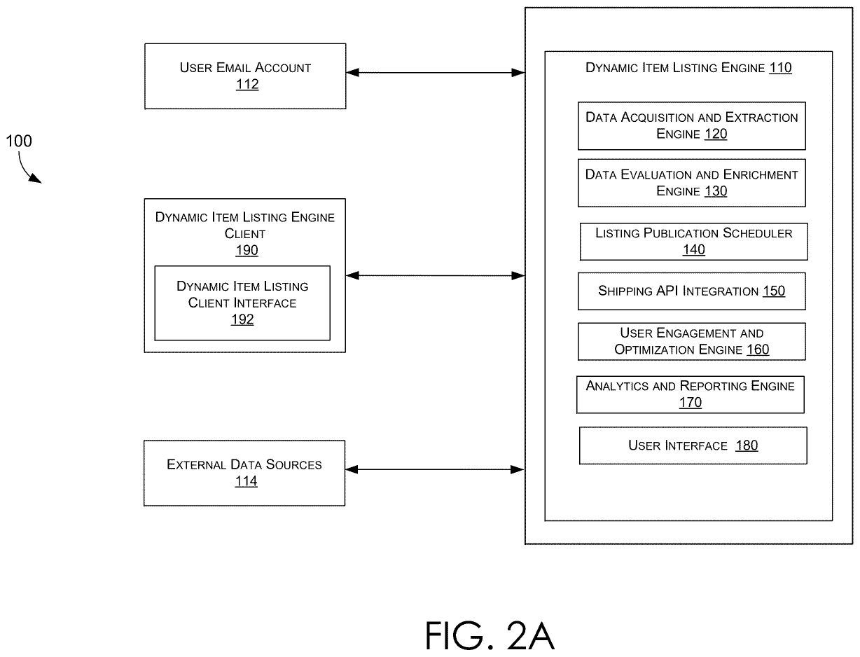

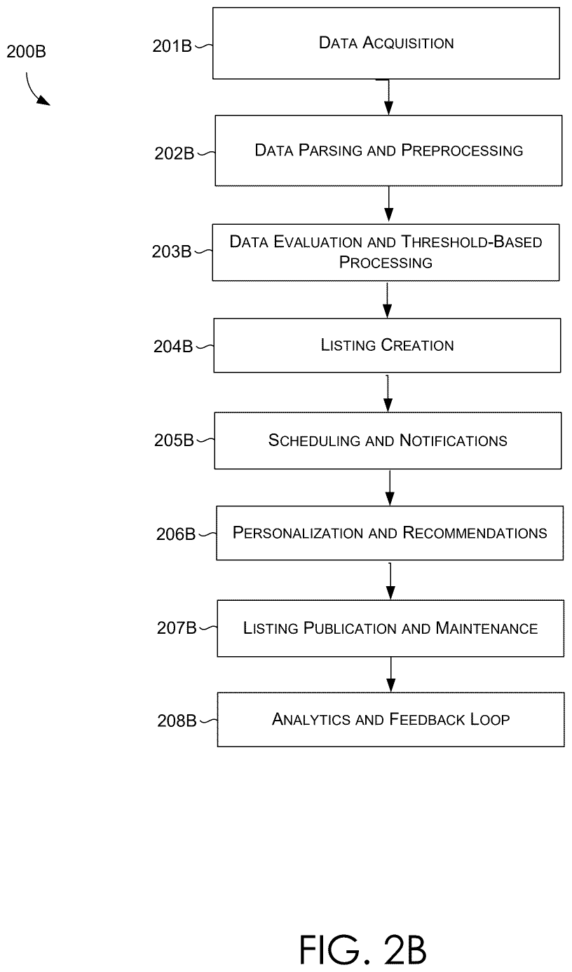

With reference to FIG. 2A, FIG. 2A a cloud computing system 100 (e.g., item listing system), dynamic item listing engine 110, user email account 112, and external data sources 114, data acquisition and extraction engine 120, data evaluation and enrichment engine 130, listing publication scheduler 140, shipping API integration 150, user engagement and optimization engine 160, analytics and reporting engine 170, user interface 180; and dynamic item listing engine client 190 and dynamic item listing client interface 192.

The cloud computing system 100 serves as the foundational infrastructure that offers scalable and flexible resources to host and manage all system components. The dynamic item listing engine 110 is the central orchestrator, automating the creation, optimization, and management of item listings; it receives enriched product data as inputs and outputs ready-to-publish listings for the item listing system.

The user email account 112 functions as an external data source where purchase receipts and order confirmations are received, providing the initial raw data that triggers the listing process. Complementing this, external data sources supply supplemental product information—such as high-resolution images and detailed descriptions—that augment the data extracted from emails. The data acquisition and extraction engine 120 processes inputs from the user email account 112 and external data sources by converting unstructured data into normalized product information, with outputs comprising structured data sets that include essential item details like brand, price, and specifications.

The data evaluation and enrichment engine 130 then assesses the completeness and quality of the extracted data against predefined thresholds, and if needed, enriches this data by integrating additional information, thereby producing a validated and enhanced product dataset as its output. Next, the listing publication scheduler 140 determines the optimal timing for publishing listings based on historical engagement data and seller-defined preferences, taking enriched product data as its input and outputting a scheduled timeline for when listings go live.

The shipping API integration 150 connects with external shipping carriers via their APIs to retrieve real-time shipping details—such as package dimensions, weight, shipping rates, and delivery estimates—by taking shipping-related product attributes as inputs and outputting complete shipping information that is embedded into the listing. Meanwhile, the user engagement and optimization engine 160 analyzes historical user behavior and listing performance data to generate personalized recommendations and actionable insights; its inputs are past sales and interaction data, and its outputs are optimization strategies that help sellers improve listing effectiveness.

The analytics and reporting engine 170 aggregates system-wide performance metrics, such as views, clicks, and conversion rates, processing raw data as inputs and outputting detailed analytics reports and dashboards that inform sellers about their listing performance. The user interface 180 offers an interactive platform for sellers to manage listings, view analytics, and adjust settings, accepting user commands and data from various system components as inputs and outputting a user-friendly dashboard.

The data item listing engine client 190 acts facilitates communication between external applications and the dynamic item listing engine 110 by processing requests for listing updates and retrieving data, while the dynamic item listing client interface 192 provides a specialized, interactive interface for sellers to manage their digital inventory, receive personalized notifications, and engage directly with the system. Together, these components form an integrated, cloud-based solution that automates every step of the item listing process—from data acquisition and enrichment to scheduling, shipping integration, and analytics—ensuring that sellers can efficiently create, manage, and optimize high-quality listings with minimal manual intervention.

In this way, the dynamic item listing engine 110 supports dynamically generating, updating, and publishing item listings on an item listing system by leveraging receipt data extracted from electronic communications. In one embodiment, an electronic message—typically an email receipt—is received by a dynamic item listing endpoint, which is implemented as a designated email alias. The receipt data, associated with a specific item and user, is then accessed and processed by the system to extract key item listing data, such as product description, price, and purchase details. If the extracted item listing data does not meet a predefined completeness threshold, the dynamic item listing engine 110 identifies a supplementary item listing data source—this can be an internal database within the item listing system or an external data source from a retailer—and retrieves additional information to ensure that the listing is comprehensive.

Based on the enriched data, the dynamic item listing engine 110 automatically generates an item listing on the item listing system. A dynamic item listing rule, which is a user-specific configuration defining how the item listing should be created, is applied to update one or more attributes of the listing; for instance, this rule might adjust the description or apply a discount if certain conditions are met. Subsequently, a dynamic publishing rule—another user-specific configuration—schedules the item listing for publication, determining the optimal timing for the listing to go live on the platform. These rules allow the system to tailor both the creation and publication processes according to individual seller preferences.

A dynamic item listing rule refers to a configurable set of instructions within the dynamic item listing engine that automatically governs how item listings are created and optimized based on extracted data, supplemental information, and user-defined preferences. These rules ensure that listings are tailored to meet both seller needs and platform standards without manual intervention. Examples include: Automatically categorizing an item based on its description (e.g., assigning “Men's Clothing>Jackets” for a red leather jacket); Setting a default discount (e.g., “Apply a 20% discount if the item is over 90 days old”); and Adjusting product descriptions or images to meet platform formatting requirements or buyer expectations. These rules dynamically adapt to the information available, ensuring that item listings are accurate, appealing, and ready for publication with minimal user effort.

A dynamic publishing rule refers to the parameters and conditions under which item listings are scheduled and made live on the e-commerce platform. These rules utilize data such as user preferences, historical sales trends, and platform insights to optimize the timing and visibility of published listings. Examples include: Automatically scheduling a listing to go live at a time when similar products have historically received the highest buyer engagement; Setting specific conditions for publishing, such as “Do not publish items below $20 unless they are bundled with other products; and Sending a notification to the user to review and approve the listing before it goes live, with the option to make last-minute adjustments. Dynamic publishing rules enable sellers to maximize their listing's visibility and effectiveness while maintaining control over the timing and conditions of publication.

Furthermore, the dynamic item listing engine 110 also extracts shipping information from the receipt data, including shipping-related details such as package dimensions and weight. This shipping information is then processed by interfacing with a shipping API, which returns real-time shipping options, rates, and delivery estimates that are automatically populated into the item listing. The complete item listing, now enriched with both product and shipping details, is displayed and managed through an item listing management interface. The item listing management interface can be updated in real time based on the dynamic item listing rule and the dynamic publishing rule, ensuring that sellers have full visibility and control over their digital inventory.

In addition to these operations, the dynamic item listing engine 110 analyzes receipt data from multiple receipts associated with the user to generate recommendations for creating new listings, updating existing ones, or publishing items that may have been overlooked. It can further suggest specific actions based on analysis of past listing performance and item sales data.

Finally, once the electronic communication containing the receipt data is processed, the system communicates a notification back to the user, confirming that an item listing has been generated and is scheduled for publication. This entire process is designed to be fully automated, reducing manual effort while ensuring that each item listing is complete, optimized, and published according to the user's specific configuration and market dynamics.

For clarity and efficient reference, a glossary of key terms and concepts pertinent to the technical solution is provided below.

Dynamic item listing refers to the automated process of creating, updating, and managing product listings on an e-commerce platform using real-time data. It involves integrating multiple data sources, applying business rules, and scheduling publication to ensure that listings are always current and optimized for buyer engagement.

Receipt parsing is the process of automatically extracting key information—such as product name, price, and purchase date—from purchase receipts. This technique leverages technologies like optical character recognition (OCR) and natural language processing (NLP) to convert unstructured receipt data into a structured format suitable for further processing.

Web scraping is the automated process of retrieving supplemental data from external websites, such as high-resolution images, detailed product descriptions, and technical specifications. By converting web content into structured data, web scraping enhances the product information that the system uses to create comprehensive item listings.

Data extraction involves obtaining raw information from various sources, including emails, websites, and APIs, and converting it into a format that can be used by the system. This step is critical for gathering the necessary details that will be processed further by the listing engine.

Threshold-based processing evaluates the quality and completeness of extracted data against predefined criteria. If the data does not meet these thresholds, the system automatically triggers additional processes, such as data enrichment or manual review, to ensure the final product listing is complete and accurate.

Data enrichment enhances the initially extracted data by integrating additional details from external sources such as retailer websites and product databases. This process improves data completeness and accuracy by adding high-resolution images, extended descriptions, and technical specifications to the product information.

A shipping API is an interface that connects the system with external shipping carriers to retrieve real-time shipping information. It provides essential data such as shipping rates, package dimensions, weight, and estimated delivery times, which can be automatically embedded into product listings.

User engagement refers to the interactions between the user and the system, including actions like clicks, views, and time spent on the platform. By analyzing these interactions, the system can tailor recommendations and optimize the listing process to enhance overall satisfaction and performance.

Analytics is the systematic examination of data to measure key performance metrics such as view counts, click-through rates, and conversion rates. It delivers insights that help sellers understand listing performance and guides data-driven improvements to optimize future listings.

Scheduling is the process of determining the optimal timing for actions such as the publication of item listings. It uses historical engagement data and seller preferences to set publication times that maximize visibility and buyer interaction.

A digital wardrobe is a conceptual repository that aggregates and organizes a user's purchase history and inventory of items into a virtual closet. This tool enables sellers to manage their assets more efficiently, track item performance over time, and receive personalized recommendations for future listings based on their historical data.

A supplementary item listing data source is an external or internal repository that provides additional product details to complement the primary data extracted from a receipt. It may include retailer websites, third-party product databases, or curated internal catalogs maintained by the e-commerce platform. This source ensures that the final item listing is enriched with comprehensive information such as high-resolution images, detailed descriptions, or technical specifications.

Supplementary item listing data refers to the additional information obtained from a supplementary data source to enhance the completeness of an item listing. This data may include extra product attributes, extended descriptions, images, and technical specifications that are not present in the initial receipt data. The inclusion of this supplementary data ensures that the listing is both informative and appealing to potential buyers.

An internal data source associated with the item listing system is a repository managed within the item listing system that stores structured product information and historical listings. This data source can include standardized product catalogs, past listing details, and curated information used to validate or enrich new item listings. Its purpose is to ensure consistency, accuracy, and completeness in the data used for generating item listings.

Dynamic item listing rules are user-defined configurations that specify how various attributes of an item listing should be updated automatically. These rules may dictate adjustments to pricing, categorization, descriptions, or other key listing elements based on specific conditions or triggers. By allowing users to input these rules, the system can tailor the listing creation process to individual seller preferences, ensuring consistency and optimization across all listings. In this way, at least a subset of dynamic item listing rules are provided by the user to the item listing system to support updating attributes of an item listing

Dynamic publishing rules are user-specific configurations that determine when and how item listings are published on the platform. These rules can include scheduling parameters, conditions for immediate or delayed publication, and criteria for optimizing listing visibility. By defining these rules, users can control the timing and presentation of their listings, thereby maximizing exposure and engagement with potential buyers. In this way, a subset of dynamic publishing rules is provided by the user to the item listing system to support publishing of the item listings in the item listing system.

With reference to FIG. 2B, FIG. 2B, illustrates a dynamic item listing workflow 200B associated with providing a dynamic item listing engine in accordance with embodiments described herein. The technical solution of the dynamic item listing engine can be explained by way of steps and an example.

At step 201B: Data Acquisition—The process of data acquisition begins with collecting purchase receipts. Integrations are developed with various platforms, such as email clients, text message services, and document upload systems, to gather receipts from users. A secure API is also established, enabling users to link their accounts where receipts are stored. To enrich the listings, reliable web sources and APIs, such as merchant sites and product databases, are identified to gather additional item details. Web scraping infrastructure is then set up to extract data from these different sources.

At step 202B: Data Parsing and Preprocessing—Once receipts are collected, the next step is parsing the data. A receipt parser is provided or integrated to handle different receipt formats and extract key information, such as the item name, price, merchant, and transaction date. For image-based receipts, Optical Character Recognition (OCR) technology is used to accurately extract data. After the data is parsed, it undergoes validation and sanitization to ensure it aligns with expected formats. If additional item details are missing, a web scraper is employed to retrieve high-quality images, descriptions, or product categories, adjusting to diverse website structures and dynamic content as needed.

At step 203B: Data Evaluation and Threshold-Based Processing—The parsed data is then evaluated against quality standards. Threshold criteria are established to define what constitutes a complete and acceptable listing, such as a minimum number of attributes or image quality. The dynamic item listing engine compares the extracted data to these thresholds and determines whether additional scraping or manual intervention is needed. If the data falls short of the threshold, the dynamic item listing engine triggers the web scraper or internal database queries to fill in missing details. If supplemental sources cannot meet the quality criteria, the listing is flagged for manual review.

At step 204B: Listing Creation—After the data has been evaluated, the dynamic item listing engine dynamically compiles it into a structured listing. Fields like the title, description, price, and images are pre-populated based on the extracted data and rules-based logic. The dynamic item listing engine then automatically assigns the listing to the appropriate categories on the platform, ensuring that it is organized and easy for buyers to find. The rules-based logic also comes into play to adjust details such as pricing strategies, promotional discounts, or even scheduling the listing's go-live time. This allows for a high degree of automation while still providing flexibility for sellers to configure their preferences within their dashboards.

At step 205B: Scheduling and Notifications—Once the listings are created, sellers can schedule when their items will go live. This is based on analytics that determine the optimal market timing. A scheduler manages the automated release of listings at designated times. Alongside this, sellers are notified about the status of their listings, whether they are in draft or pending approval. Reminders are sent for upcoming promotions, incomplete drafts, or recommended updates, keeping sellers informed and allowing them to stay on top of their listings with ease.

At step 206B: Personalization and Recommendations—Personalization functionality is supported to optimize listing performance. A recommendation engine leverages user purchase history and listing activity to offer tailored suggestions. These might include bundling items, adjusting prices, or highlighting similar products for listing. Over time, the dynamic item listing engine refines its recommendations by using machine learning models that improve its accuracy as more data is gathered. The dynamic item listing engine also provides an intuitive dashboard, allowing sellers to view and act on these recommendations with minimal effort. Performance analytics are integrated to guide sellers on how their listings are doing and where improvements might be made.

At step 207B: Listing Publication and Maintenance—When a listing meets quality criteria or is approved by the seller, it is automatically transitioned from draft to live status. At this stage, the dynamic item listing engine ensures that metadata, such as tags and keywords, is optimized for better discoverability within the platform. Once live, listings are continually updated based on real-time data or predefined rules. This includes automatic adjustments to prices, stock levels, or promotional details. Sellers also have the ability to manually edit their listings after publication, providing flexibility for ongoing maintenance and improvements.

At step 208B: Analytics and Feedback Loop—The dynamic item listing engine tracks performance metrics, including views, clicks, and sales, to provide insights into how listings are performing. These analytics highlight underperforming listings and offer actionable suggestions for improvement. As the dynamic item listing engine collects more data, it continually refines its processes. For instance, the receipt parsing algorithms, scraper accuracy, and recommendation engine are all improved based on performance data. User feedback also plays a critical role in this loop, helping to enhance the system's usability and functionality over time.

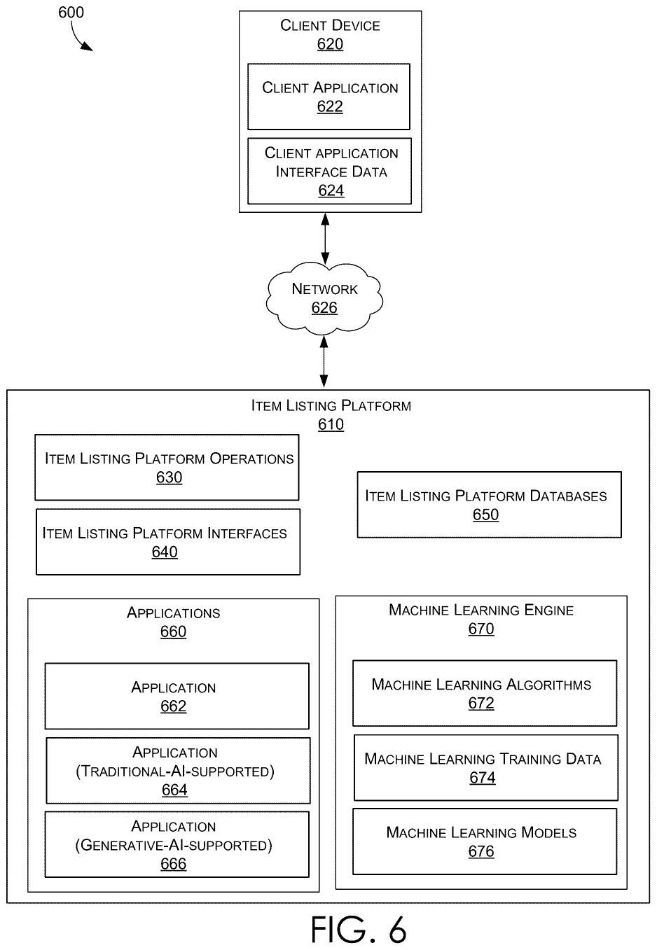

Aspects of the technical solution can be described by way of examples and with reference to FIGS. 1A, 1B, 2A, and 2B. FIG. 2A is a block diagram of an exemplary technical solution environment, based on example environments described with reference to FIGS. 6, 7, and 8 for use in implementing embodiments of the technical solution are shown. Generally the technical solution environment includes a technical solution system suitable for providing the example item listing system 600 in which methods of the present disclosure may be employed. In particular, FIG. 2A shows a high-level architecture of the cloud computing system 100 in accordance with implementations of the present disclosure. Among other engines, managers, generators, selectors, or components not shown (collectively referred to herein as “components”), the cloud computing system 100 of FIG. 2A support functionality described in FIGS. 1A and 1B.

### Example Methods

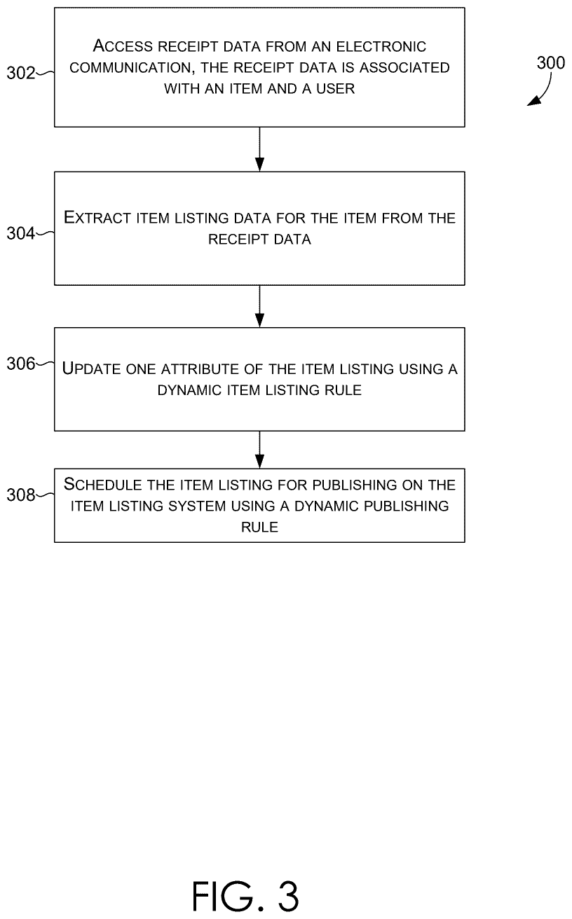

With reference to FIGS. 3, 4, and 5 flow diagrams that illustrate methods for providing a dynamic item listing engine in an artificial intelligence system. The methods may be performed using the artificial intelligence system described herein. In embodiments, one or more computer-storage media having computer-executable or computer-useable instructions embodied thereon that, when executed, by one or more processors can cause the one or more processors to perform the methods (e.g., computer-implemented method) in an item listing system (e.g., computerized system or computer system).

Turning to FIG. 3, a flow diagram is provided that illustrates a method 300 for providing a dynamic item listing engine in an item listing system. At block 302, the dynamic item listing engine accesses receipt data from an electronic communication, the receipt data is associated with an item and a user. At block 304, the dynamic item listing engine extracts item listing data for the item from the receipt data. At block 306, based on the item listing data, the dynamic item listing engine automatically generates an item listing for the item on an item listing system. At block 308, the dynamic item listing engine uses a dynamic item listing rule to update one attribute of the item listing, the dynamic item listing rule is a first user-specific configuration that determines a creation of the item listing. At block 310, the dynamic item listing engine uses a dynamic publishing rule to schedule the item listing for publishing on the item listing system, wherein the dynamic publishing rule is a second user-specific configuration that determines a publishing of the item listing.

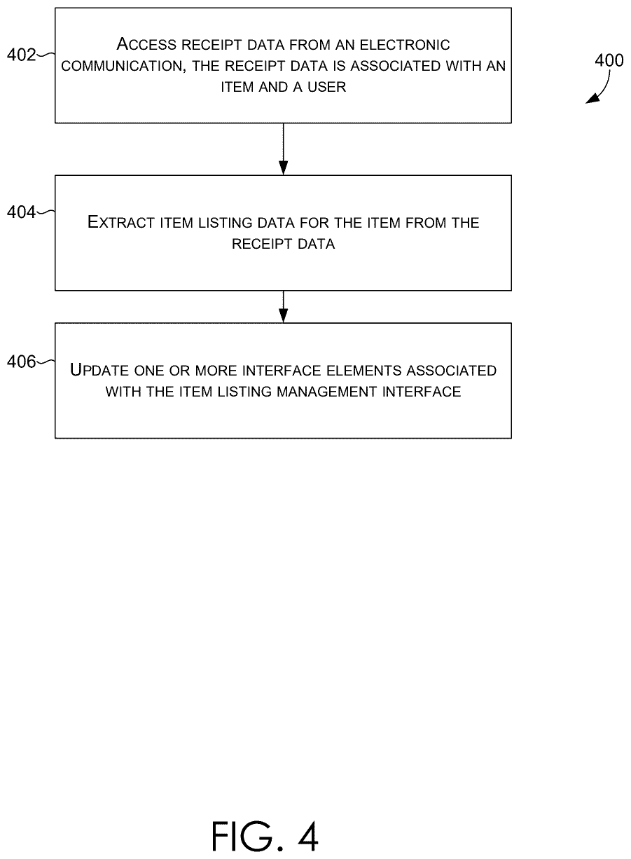

Turning to FIG. 4, a flow diagram is provided that illustrates a method 400 for providing a dynamic item listing engine in an item listing system. At block 402, dynamic item listing engine accesses receipt data from an electronic communication, the receipt data is associated with an item and a user. At block 404, dynamic item listing engine extracts item listing data for the item from the receipt data. At block 406, based on the item listing data, dynamic item listing engine automatically generates an item listing for the item on an item listing system. At block 408, dynamic item listing engine updates one or more interface elements associated with an item listing management interface, updating the item listing management interface is based on a dynamic item listing rule and a dynamic publishing rule.

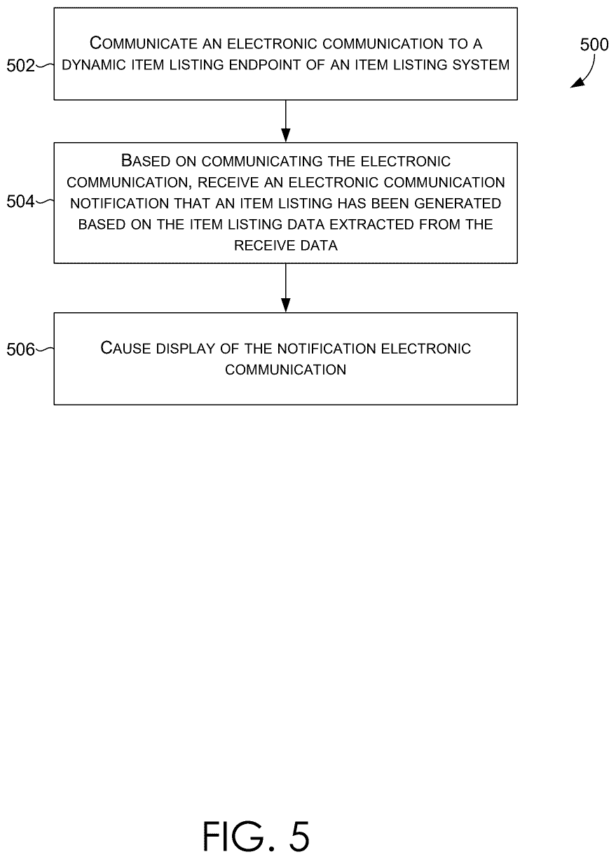

Turning to FIG. 5, a flow diagram is provided that illustrates a method 500 for providing a dynamic item listing engine in an item listing system. At block 502, the dynamic item listing engine client communicates an electronic communication to a dynamic item listing endpoint of an item listing system, the electronic communication comprises receipt data associated with a user. At block 504, based on communicating the electronic communication, the dynamic item listing engine client communicates receives a notification electronic communication that an item listing has been generated based on the item listing data extracted from the receipt data. At block 506, the dynamic item listing engine client communicates cause display of the notification electronic communication.

### Technical Improvement

Embodiments of the present invention have been described with reference to several inventive features (e.g., operations, systems, engines, and components) associated with an item listing system. Inventive features described include operations, interfaces, data structures, and arrangements of computing resources associated with providing the functionality described herein relative with reference to a dynamic item listing engine associated with an item listing system.

Embodiments of the present invention relate to the field of computing, and more particularly to an item listing system. The following described exemplary embodiments provide a system, method, and program product to, among other things, execute generative item listing operations that provide a dynamic item listing engine. Therefore, the present embodiments improve the technical field of item listing technology enhancing the efficiency and effectiveness item listing system.

The technical solution operates through operations that automate and optimize the item listing process. Initially, purchase receipts are automatically captured from the user's email and external sources, after which the dynamic item listing engine extracts and standardizes product information using tools like a receipt parser and web scraper. This structured data is then evaluated for completeness by a threshold-based processing module, which enriches it when necessary. The listing publication scheduler determines the best time to go live based on engagement data and seller preferences. The shipping API integration retrieves real-time shipping details, such as dimensions, weight, rates, and delivery estimates, from carriers. Finally, the analytics engine tracks listing performance, offering personalized recommendations to optimize future listings.

Advantageously, the adaptive threshold evaluation mechanism, powered by machine learning algorithms, dynamically adjusts quality criteria for data evaluation and enrichment, reducing the need for manual intervention. The intelligent scheduling algorithm leverages real-time engagement analytics and historical performance data to automatically select the most advantageous publication times for listings, ensuring maximum visibility and buyer engagement. And a multi-carrier shipping optimization feature aggregates shipping data from various external carriers and employs advanced algorithms to determine the most cost-effective and reliable shipping option based on item attributes and destination.

Functionality of the embodiments of the present invention have further been described, by way of an implementation and anecdotal examples—to demonstrate that the operations for providing dynamic item listing using a dynamic item listing engine in an artificial intelligence system as a solution to a specific problem in artificial intelligence technology to improve computing operations in artificial intelligence systems. Overall, these improvements result in less CPU computation, smaller memory requirements, and increased flexibility in item listing systems when compared to previous conventional item listing systems operations performed for similar functionality.

### Additional Support for Detailed Description of the Invention Example Item Listing System Environment

Referring now to FIG. 6, FIG. 6 illustrates an example item listing system 600 computing environment in which implementations of the present disclosure may be employed. In particular, FIG. 6 shows a high-level architecture of an example item listing platform 610 that can host a technical solution environment, or a portion thereof. It should be understood that this and other arrangements described herein are set forth as examples. For example, as described above, many elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The item listing system 600 can be a cloud computing environment that provides computing resources for functionality associated with the item listing platform 610. For example, the item listing system 600 supports delivery of computing components and services—including servers, storage, databases, networking, applications, and machine learning associated with the item listing platform 610 and client device 620. A plurality of client devices (e.g., client device 620) include hardware or software that access resources on the item listing system 600. Client device 620 can include an application (e.g., client application 622) and interface data (e.g., client application interface data 624) that support client-side functionality associated with the item listing system. The plurality of client devices can access computing components of the item listing system 600 via a network (e.g., network 626) to perform computing operations.

The item listing platform 610 is responsible for providing a computing environment or architecture that includes the infrastructure that supports providing item listing platform functionality (e.g., e-commerce functionality). The item listing platform support storing item in item databases and providing a search system for receiving queries and identifying search results based on the queries. The item listing platform may also provide a computing environment with features for managing, selling, buying, and recommending different types of items. Item listing platform 610 can specifically be for a content platform such as EBAY content platform or e-commerce platform, developed by EBAY INC., of San Jose, California.

The item listing platform 610 can provide item listing operations 630 and item listing interfaces 640. The item listing operations 630 can include service operations, communication operations, resource management operations, security operations, and fault tolerance operations that support specific tasks or functions in the item listing platform 610. The item listing interfaces 640 can include service interfaces, communication interfaces, resource interfaces, security interfaces, and management and monitoring interfaces that support functionality between the item listing platform components. The item listing operations 630 and item listing interfaces 640 can enable communication, coordination and seamless functioning of the item listing system 600.

By way of example, functionality associated with item listing platform 610 can include shopping operations (e.g., product search and browsing, product selection and shopping cart, checkout and payment, and order tracking); user account operations (e.g., user registration and authentication, and user profiles); seller and product management operations (e.g., seller registration and product listing and inventory management); payment and financial operations (e.g., payment processing, refunds and returns); order fulfillment operations (e.g., order processing and fulfillment and inventory management); customer support and communication interfaces (e.g., customer support chat/email and notifications); security and privacy interfaces (e.g., authentication and authorization, payment security); recommendation and personalization interfaces (e.g., product recommendations and customer reviews and ratings); analytics and report interfaces (e.g., sales and inventory reports, and user behavior analytics); and APIs and Integration Interfaces (e.g., APIs for Third-Party Integration).

The item listing platform 610 can provide item listing platform databases (e.g., item listing platform databases 650) to manage and store different types of data efficiently. The item listing platform databases 650 can include relational databases, NoSQL databases, search databases, cache databases, content management systems, analytics databases, payment gateway database, customer relationship management databases, log and error databases, inventory and supply chain databases, and multi-channel databases that are used in combination to efficiently manage data and provide e-commerce experience for users.

The item listing platform 610 supports applications (e.g., applications 660) that is a computer program or software component or service that serves a specific function or set of functions to fulfil a particular item listing platform requirement or user requirement. Applications can be client-side (user-facing) and server-side (backend). Applications can also include application without any AI support (e.g., application 662) application supported by traditional AI model (e.g., application 664), and applications supported by generative AI models (e.g., application 666). By way of example, applications can include an online storefront application, mobile shopping app, admin and management console, payment gateway integration, user account and authentication application, search and recommendation engines, inventory and stock management application, order processing and fulfillment application, customer support and communication tools, content management system, analytics and report applications, marketing and promotion applications, multi-channel integration applications, log and error tracking applications, customer relationship management (CRM) applications, security applications, and APIs and web services that are used in combination to efficiently deliver e-commerce experiences for users.

The items listing platform 610 can include a machine learning engine (e.g., machine learning engine 670). The machine learning engine 670 refers to machine learning framework or machine learning platform that provides the infrastructure and tools to design, train, evaluate, and deploy machine learning models. The machine learning engine 670 can serve as the backbone for developing and deploying machine learning applications and solutions. Machine learning engine 670 can also provide tools for visualizing data and model results, as well as interpreting model decisions to gain insights into how the model is making predictions.

The machine learning engine 670 can provide the necessary libraries, algorithms, and utilities to perform various tasks within the machine learning workflow. The machine learning workflow can include data processing, model selection, model training, model evaluation, hyperparameter tuning, scalability, model deployment, inference, integration, customization, data visualization. Machine learning engine 670 can include pre-trained models for various tasks, simplifying the development process. In this way, the machine learning engine 670 can streamline the entire machine learning process, from data preparation and model training to deployment and inference, making it accessible and efficient for different types of users (e.g., customers, data scientists, machine learning engineers, and developers) working on a wide range of machine learning applications.

Machine learning engine 670 can be implemented in the item listing system 600 as a component that leverages machine learning algorithms and techniques (e.g., machine learning algorithms 672) to enhance various aspects of the item listing dynamic item listing engine's functionality. Machine learning engine 670 can provide a selection of machine learning algorithms and techniques used to teach computers to learn from data and make predictions or decisions without being explicitly programmed. These techniques are widely used in various applications across different industries, and can include the following examples: supervised learning (e.g., linear regression: classification, support vector machines (SVM); unsupervised learning (e.g., clustering, principal component analysis (PCA), association rules (e.g., apriori); reinforcement learning (e.g., Q-Learning, deep Q-Network (DQN); and deep learning (e.g., neural networks, convolutional neural networks (CNN), and recurrent neural networks (RNN); and ensemble learning random forest.

Machine learning training data 674 supports the process of building, training, and fine-tuning machine learning models. Machine learning training data 674 consists of a labeled dataset that is used to teach a machine learning model to recognize patterns, make predictions, or perform specific tasks. Training data typically comprises two main components: input feature (X) and labels or target values (Y). Input features can include variables, attributes, or characteristics used as input to the machine learning model. Input features (X) can be numeric, categorical, or even textual, depending on the nature of the problem. For example, in a model for predicting house prices, input features might include the number of bedrooms, square footage, neighborhood, and so on. Labels or target values (Y) include the values that the model aims to predict or classify. Labels represent the desired output or the ground truth for each corresponding set of input features. For instance, in a spam email classifier, the labels would indicate whether each email is spam or not (i.e., binary classification). The training process involves presenting the model with the training data, and the model learns to make predictions or decisions by identifying patterns and relationships between the input features (X) and the target values (Y). A machine learning algorithm adjusts its internal parameters during training in order to minimize the difference between its predictions and the actual labels in the training data. Machine learning engine 670 can use historical and real-time data to train models and make predictions, continually improving performance and user experience.

Machine learning engine 670 can include machine learning models (e.g., machine learning models 676) generated using the machine learning engine workflow. Machine learning models 676 can include generative AI models and traditional AI models that can both be employed in the item listing system 600. Generative AI models are designed to generate new data, often in the form of text, images, or other media, based on patterns and knowledge learned from existing data. Generative AI models can be employed in various ways including content generation, product image generation, personalized product recommendations, natural language chatbots, and content summarization. Traditional AI models encompass a wide range of algorithms and techniques and can be employed in various ways including recommendation systems, predictive analytics, search algorithms, fraud detection, customer segmentation, image classification, Natural Language Processing (NLP) and A/B testing and optimization. In many cases, a combination of both generative and traditional AI models can be employed to provide a well-rounded and effective e-commerce experience, combining data-driven insights and creativity.

Machine learning engine 670 can be used to analyze data, make predictions, and automate processes to provide a more personalized and efficient shopping experience for users. By way of example, product recommendations search and filtering: pricing optimization, inventory and stock management: customer segmentation, churn prediction and retention, fraud detection, sentiment analysis, customer support and chatbots, image and video analysis, and ad targeting and marketing. The specific applications of machine learning within the item listing platform 610 can vary depending on the specific goals, available data, and resources.

### Example Distributed Computing System Environment

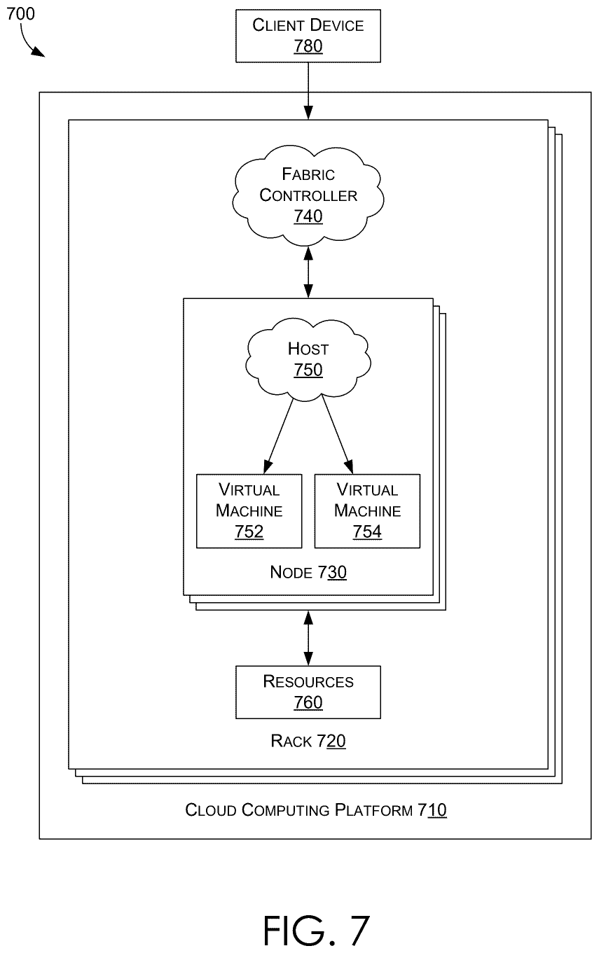

Referring now to FIG. 7, FIG. 7 illustrates an example distributed computing environment 700 in which implementations of the present disclosure may be employed. In particular, FIG. 7 shows a high-level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 800 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

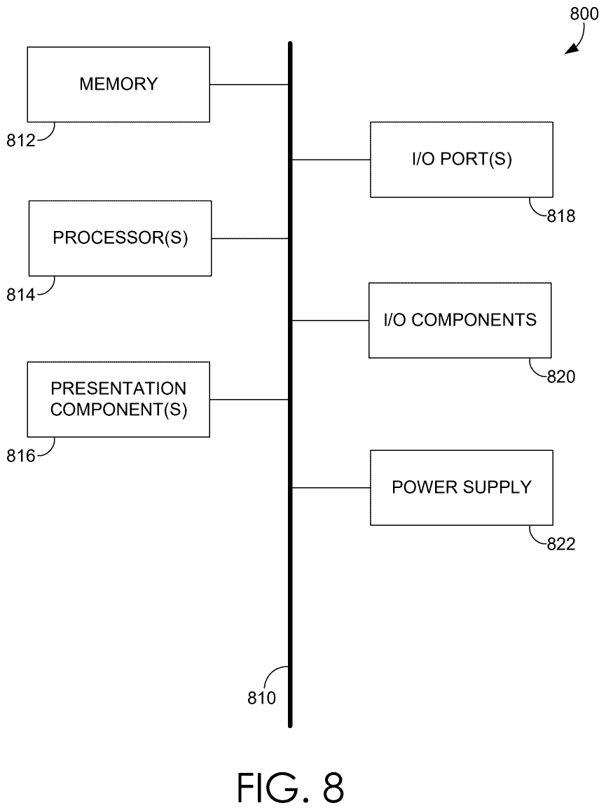

Having briefly described an overview of embodiments of the present invention, an example operating environment in which embodiments of the present invention may be implemented is described below in order to provide a general context for various aspects of the present invention. Referring initially to FIG. 8 in particular, an example operating environment for implementing embodiments of the present invention is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art and reiterate that the diagram of FIG. 8 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious, and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing receipt data from an electronic communication, wherein the receipt data is associated with an item and a user;
extracting item listing data for the item from the receipt data;
based on the item listing data, automatically generating an item listing for the item on an item listing system;
using a dynamic item listing rule, updating one attribute of the item listing, wherein the dynamic item listing rule is a first user-specific configuration that determines a creation of the item listing; and
using a dynamic publishing rule, scheduling the item listing for publishing on the item listing system, wherein the dynamic publishing rule is a second user-specific configuration that determines a publishing of the item listing.

2. The system of claim 1, wherein the electronic communication is an electronic message, and the receipt data is accessed via the electronic message that is communicated to a dynamic item listing endpoint, wherein the dynamic item listing endpoint supports processing electronic messages for dynamic item listings.

3. The system of claim 2, wherein the electronic message is an email, and the dynamic item listing endpoint is an email alias.

4. The system of claim 1, the operations further comprising:
determining that the item listing data does not meet a predefined completeness threshold;
identifying a supplementary item listing data source;
retrieving supplementary item listing data from the supplementary item listing data sources; and
based on the item listing data and the supplementary item listing data, generating the item listing for the item.

5. The system of claim 4, wherein the supplementary item listing data source is an internal data source associated with the item listing system, or an external data source of a retailer identified using the receipt data.

6. The system of claim 4, wherein the item listing system comprises a dynamic item listing engine that integrates via Application Programming Interfaces and plugins with data sources to retrieve the item listing data associated with the receipt data.

7. The system of claim 1, wherein at least a subset of dynamic item listing rules is provided by the user to the item listing system to support updating attributes of item listings, and wherein a subset of dynamic publishing rules is provided by the user to the item listing system to support publishing of the item listings in the item listing system.

8. The system of claim 1, wherein the item listing system provides a dynamic item listing interface that supports configuring user preferences associated with dynamic item listing functionality and managing dynamic item listings in the item listing system.

9. The system of claim 1, wherein the item listing is one of a plurality of item listings that are dynamically generated based on receipt data associated with the user.

10. The system of claim 1, the operations further comprising:
analyzing receipt data associated with a plurality of receipts of the user; and
based on analyzing the receipt data, generating a recommendation to create a new item listing, publish the new item listing, or update the new item listing.

11. The system of claim 1, the operations further comprising generating a suggested action for the item listing based on analyzing item listing system data associated with item listings and item sales on the item listing system.

12. The system of claim 1, the operations further comprising:
extracting shipping information from the receipt data, wherein the extracted shipping information comprises shipping-related item details;
based on the extracted shipping information, interfacing with a shipping API to process the shipping information; and
automatically populating shipping information for the item listing based on the shipping-related item details of the extracted shipping information.

13. A computer-implemented method, the computer-implemented method comprising:
accessing receipt data from an electronic communication, wherein the receipt data is associated with an item;
extracting item listing data for the item from the receipt data;
based on the item listing data, automatically generating an item listing for the item on an item listing system; and
updating one or more interface elements associated with an item listing management interface, wherein updating the item listing management interface is based on a dynamic item listing rule and a dynamic publishing rule.

14. The computer-implemented method of claim 13, the method further comprising using the dynamic item listing rule, updating one attribute of the item listing, wherein the dynamic item listing rule is a first user-specific configuration that determines a creation of the item listing.

15. The computer-implemented method of claim 13, the method further comprising using the dynamic publishing rule, scheduling the item listing for publishing on the item listing system, wherein the dynamic publishing rule is a second user-specific configuration that determines a publishing of the item listing.

16. The computer-implemented method of claim 13, the method further comprising:
extracting shipping information from the receipt data, wherein the extracted shipping information comprises shipping-related item details;
based on the extracted shipping information, interfacing with a shipping API to process the shipping information; and
automatically populating shipping information for the item listing based on the shipping-related item details of the extracted shipping information.

17. One or more computer-storage media having computer-executable instructions embodied thereon that, when executed by a computing system having a processor and memory, cause the processor to perform operations, the operations comprising:
communicating an electronic communication to a dynamic item listing endpoint of an item listing system, wherein the electronic communication comprises receipt data associated with a user;
based on communicating the electronic communication, receiving a notification electronic communication, wherein the notification electronic communication indicates that an item listing has been generated based on the item listing data extracted from the receipt data; and
causing display of the notification electronic communication.

18. The media of claim 17, wherein the electronic communication is an electronic message, and the receipt data is accessed via the electronic message that is communicated to a dynamic item listing endpoint, wherein the dynamic item listing endpoint supports processing electronic messages for dynamic item listings.

19. The media of claim 17, wherein at least a subset of dynamic item listing rules is provided by the user to the item listing system to support updating attributes of item listings, and wherein a subset of dynamic publishing rules is provided by the user to the item listing system to support publishing of the item listings in the item listing system.

20. The media of claim 17, wherein the notification electronic communication comprises shipping information for the item listing based on shipping-related item details of extracted shipping information from the receipt data.
